(19) United States
(12) Patent Application Publication
(10) Pub. No.: US 2022/0038043 A1
(43) Pub. Date: Feb. 3, 2022

(54) ELECTROMAGNETIC FILTERING OF A CONTROL CIRCUIT OF AN ELECTRIC MOTOR

(71) Applicant: Valeo Systemes Thermiques, Le Mesnil-Saint-Denis Cedex (FR)

(72) Inventors: David Bonneau, Le Mesnil Saint Denis (FR); Julien Berthelot, Le Mesnil Saint Denis (FR); William Lapierre, Le Mesnil Saint Denis Cedex (FR); Lucien Le Curieux-Belfond, Le Mesnil Saint Denis (FR)

(73) Assignee: Valeo Systemes Thermiques, Le Mesnil-Saint-Denis Cedex (FR)

(21) Appl. No.: 17/278,852

(22) PCT Filed: Sep. 25, 2019
(86) PCT No.: PCT/FR2019/052271

§ 371 Date: Mar. 23, 2021

(30) Foreign Application Priority Data
Sep. 25, 2018 (FR) 1858767

(51) Int. Cl. H02P 29/50; H02P 27/08; B60R 16/03; F04D 25/06

(52) U.S. Cl. CPC H02P 29/50; F04D 25/06; B60R 16/03; H02P 27/08

(57) ABSTRACT

The invention relates to a control circuit (1) of an electric motor (4), the control circuit (1) comprising a filtering device (13) in order to filter the high frequencies likely to produce perturbing electromagnetic radiation when the electric motor (4) is driven. To this end, the filtering device (13) comprises a first filtering device (131) branched off from a power bridge (12) driving the electric motor (4), each filtering branch forming the first filtering device (131) being located near the power bridge (12) and/or one of the corresponding power branches (A, B, C) of said power bridge (12) so that a length of an electrical conductor (1313) connecting said filtering branch to said power branch is less than 20 mm. The invention also relates to a motorized-fan unit (8) for motor vehicles comprising such a control circuit (1).

### TECHNICAL FIELD

The technical context of the present invention is that of protection against electromagnetic radiation. More particularly, the invention relates to a control circuit of an electric motor, in particular of the type of those used in motor vehicle front face fan assemblies. The invention also relates to a motorized-fan unit for motor vehicles, driven by such a motor control circuit.

### PRIOR ART

Motorized-fan units allowing regulation of an air flow sufficient to cool multiple elements of motor vehicles, such as for example an internal combustion engine or an electric circuit, are known. Such motorized-fan units comprise a rotatable fan and an electric motor for rotating the fan, the electric motor being driven by a control circuit.

The ever-increasing integration of electrical equipment in a motor vehicle leads to greater proximity among said electrical equipment. Therefore, the very operation of the various items of electrical equipment can perturb neighboring electrical equipment. Consequently, automotive manufacturers impose ever greater electromagnetic compatibility (EMC) constraints in order to guarantee reliable operation firstly of motor vehicles and secondly of the various functions provided.

These electromagnetic compatibility requirements are also imposed on the control circuit of the electric motor of motorized-fan units. This is because when the electric motor is driven by a power bridge of the control circuit, the generation of a pulse-width modulation control signal produces electromagnetic radiation that is likely to perturb the other electrical equipment and to propagate to an electrical system of the electric vehicle.

It is an object of the present invention to propose a novel control circuit in order to overcome, at least to a large extent, the earlier problems and also bring about further advantages. More particularly, an aim of the invention is to reduce the electromagnetic emissions of such a control circuit during operation thereof and to limit the electrical perturbations for the electrical system of a motor vehicle.

### DISCLOSURE OF THE INVENTION

According to a first aspect of the invention, at least one of the aforementioned objectives is achieved with a control circuit of an electric motor, the control circuit comprising (i) a power bridge comprising at least one power branch, the power bridge being configured to drive the electric motor, and (ii) a first filtering device comprising at least one filtering branch arranged in parallel with the power bridge via two connection terminals, in order to filter electromagnetic radiation from said power bridge. According to the invention, at least one of the connection terminals of the first filtering device is located near a connection point of the power bridge, so that a length of an electrical conductor connecting said connection terminal of the first filtering device to the connection point of the power bridge is less than or equal to 20 mm.

Thus, the proximity between power switches forming the power bridge and one of the connection terminals of the first filtering device allows a parasitic effect at this electrical connection between said power bridge and said first filtering device, generally exhibiting inductive and/or capacitive coupling, to be limited. Consequently, the first filtering device allows an amplitude of the electromagnetic perturbations that arise when the power bridge is operating to be attenuated. The invention in accordance with its first aspect thus allows these perturbations to be attenuated as closely as possible to the location at which they originate, rather than attenuating them through longer conductive links serving as antennas for the electromagnetic perturbations that are intended to be eliminated. The proximity between one of the connection terminals of the first filtering device and the power bridge also allows a number of electrical connections between said first filtering device and said power bridge to be limited, each of these electrical connections located between the first filtering device and the power bridge having the effect of reducing the efficiency of such a filtering device. Consequently, the invention in accordance with its first aspect allows electrical perturbations on a motor vehicle electrical system to be reduced, if the control circuit is implemented on a motor vehicle.

The electric motor intended to be driven by the control circuit is advantageously of the type of a DC electric motor. In general, the electric motor intended to be driven by the control circuit in accordance with the first aspect of the invention is of the type of any polyphase electric motor, and in particular a brushless motor, of the type of a synchronous electric machine.

Each power branch of the power bridge of the control circuit in accordance with the first aspect of the invention comprises one or more—and preferably two—power switches. Each power switch is configured to generate an electrical pulse-width modulation power signal in order to control the rotation and/or speed of rotation of the electric motor to which the control circuit is connected. For this purpose, each power switch is alternately configured in an on conduction state—in which it has a very low resistance between its terminals—and in an off conduction state—in which it has a very high resistance between its terminals. Toggling the power switch between its on and off conduction states thus allows the power signal of the pulse-width modulation type to be generated and allows its characteristics, such as for example a frequency and/or a duty cycle of said power signal, to be controlled.

During its operation, the control circuit is a source of electromagnetic radiation, mainly due to the successive switching of the power switch(es) of the power bridge. The first filtering device thus allows sudden variations in electric current that can appear when the electric motor is rotating, and in particular when the power switches open or close when they switch from their on conduction state to their off conduction state, or vice versa, to be filtered. This is because the first filtering device has an electrical impedance that is dependent on the frequency of the electric current flowing through it: for sudden variations in electric current—at the moment at which the electrical switching of the power switch(es) is established—the electrical impedance of the first filtering device is very high. On the other hand, for smaller variations in electric current—when the power switch(es) has switched to one of its conduction states—the electrical impedance of the first filtering device is very low.

In other words, the first filtering device behaves essentially as a filter of low-pass type, a cutoff frequency of which determines its behavior vis-a-vis the electric current passing through it:
beyond the cutoff frequency, the electrical impedance seen by the electric current passing through the first filtering device is very large, and the electric current passing through said first filtering device is thus greatly attenuated;
below the cutoff frequency, the electrical impedance seen by the electric current passing through the first filtering device is very small, and the electric current passing through said first filtering device is attenuated little or not at all.

As will be examined later on, the cutoff frequency of the filtering device depends on the electrical characteristics of the components that form the first filtering device.

The control circuit in accordance with the first aspect of the invention advantageously comprises at least one of the refinements below, the technical characteristics forming these refinements being able to be taken alone or in combination:
the power switch(es) of the power bridge are of the type of a power transistor. According to a particular embodiment, the power switch(es) are of the type of a field effect transistor. More particularly still, the power switch(es) are of the type of a MOSFET, the acronym for “Metal Oxide Semiconductor Field Effect Transistor”, or of the type of a bipolar transistor, for example of IGBT type, the acronym for “Insulated Gate Bipolar Transistor”;
each connection terminal of the first filtering device is located near a connection point of the power bridge, so that a length of the electrical conductor connecting each connection terminal of the first filtering device to the corresponding connection point of the power bridge is less than or equal to 20 mm. In this advantageous configuration, the two connection terminals of the first filtering device are located near the corresponding connection point of the power bridge, so as to minimize the length of the electrical conductor connecting the first filtering device to the power bridge. Advantageously, the length of the electrical conductor connecting the power bridge to the first connection terminal of the first filtering device is equal to the length of the electrical conductor connecting said power bridge to the second connection terminal of the first filtering device;
the first filtering device comprises a number of filtering branches equal to a number of power branches of the power bridge, each filtering branch being associated with a single power branch, so that a length of the electrical conductor connecting the connection terminal of each filtering branch to the corresponding connection point of the power branch is less than or equal to 20 mm;
the first filtering device is of the type of a low-pass filter, a cutoff frequency of which is between 800 kHz and 1.2 MHz. The first filtering device thus allows parasitic electromagnetic perturbations that arise at the ends of the power bridge and that have the effect of chopping a supply voltage at a frequency of several kilohertz, which then creates a cascade of harmonics greater than the origin of the electromagnetic perturbations, to be filtered. The use of the first filtering device—as close as possible to the power bridge—thus allows firstly better sizing of the cutoff frequency of the first filtering device and secondly limiting of the propagation of electromagnetic perturbations and the radiation by antenna through the control circuit.
preferably, the cutoff frequency of the first filtering device is approximately equal to 1 MHz plus or minus 5%. According to a first embodiment, the cutoff frequency of the first filtering device is the same for all the filtering branches of said first filtering device. According to a second, alternative embodiment, each filtering branch has a predefined cutoff frequency, possibly different than that of the other filtering branches;
each filtering branch of the first filtering device comprises at least one filtering capacitor;
a capacitance value of the filtering capacitor(s) of the first filtering device is greater than 1 mF. Preferably, a capacitance value of the filtering capacitor(s) of the first filtering device is equal to 2700 μF;
the filtering capacitor of each filtering branch of the first filtering device is of the type of an electrolytic capacitor;
the control circuit comprises a second filtering circuit comprising at least one filtering branch arranged in parallel with the power bridge via two connection terminals. In a manner comparable to the first filtering circuit, the second filtering circuit allows sudden variations in electric current that can appear in the control circuit, and in particular when the power switches of the power bridge open or close, to be filtered, as mentioned earlier. For this purpose, the second filtering device behaves essentially as a filter of low-pass type, a cutoff frequency of which determines its behavior vis-a-vis the electric current passing through it, as mentioned earlier with reference to the first filtering device;
a cutoff frequency of the second filtering circuit is greater than a cutoff frequency of the first filtering circuit. This advantageous configuration allows better configuration of the dynamic behavior of the first and second filtering devices of the control circuit, and better attenuation of the electromagnetic radiation from the control circuit during operation thereof;
each connection terminal of the second filtering device is located near a connection point of the power bridge, so that a length of the electrical connector connecting each connection terminal of the second filtering device to the corresponding connection point of the power bridge is less than or equal to 20 mm;
the second filtering device comprises a number of filtering branches equal to a number of power branches of the power bridge, each filtering branch being associated with a single power branch, so that a length of the electrical connector connecting the connection terminal of each filtering branch to the corresponding connection point of the power branch is less than or equal to 20 mm;
the second filtering device is of the type of a low-pass filter, a cutoff frequency of which is greater than or equal to 100 MHz;
each filtering branch of the second filtering device comprises a filtering capacitor;
a capacitance value of the filtering capacitor(s) of the second filtering device is less than 1 μF. Preferably, a capacitance value of each filtering capacitor of the second filtering device is between 100 nF and 600 nF;
the filtering capacitor of each filtering branch of the second filtering device is of the type of a capacitive film or a ceramic capacitor. This advantageous configuration makes it possible to obtain lower capacitance values in order to exhibit better dynamic performance and, finally, better electromagnetic filtering.

According to a second aspect of the invention, a motorized-fan unit for motor vehicles is proposed, said motorized-fan unit comprising (i) a fan rotated by an electric motor, and (ii) a control circuit in accordance with the first aspect of the invention or in accordance with any one of the refinements thereof, said control circuit being configured to drive the electric motor.

The control circuit is configured to control a speed of rotation and/or a direction of rotation of the electric motor and, consequently, of the associated fan.

Varying embodiments of the invention are foreseeable, these incorporating the various optional features explained here in all of their possible combinations.

### DESCRIPTION OF THE FIGURES

Further features and advantages of the invention will become apparent from the following description and from several exemplary embodiments given as non-limiting examples with reference to the attached schematic drawings, in which:

FIG. 1 illustrates a circuit diagram of an electric motor driven by a control circuit in accordance with the first aspect of the invention;

FIG. 2 illustrates a first exemplary embodiment of such a control circuit in accordance with the first aspect of the invention;

FIG. 3 illustrates a second exemplary embodiment of such a control circuit in accordance with the first aspect of the invention.

Of course, the features, variants and different embodiments of the invention can be combined with one another, in various combinations, provided that they are not incompatible or mutually exclusive. In particular, variants of the invention can be envisaged that comprise only a selection of the features described below in isolation from the other features described, if this selection of features is sufficient to provide a technical advantage or to distinguish the invention from the prior art.

In particular, all of the variants and all of the embodiments described can be combined with each other if there is no technical reason preventing this combination.

In the figures, elements common to a number of figures keep the same reference.

### DETAILED DESCRIPTION OF THE INVENTION

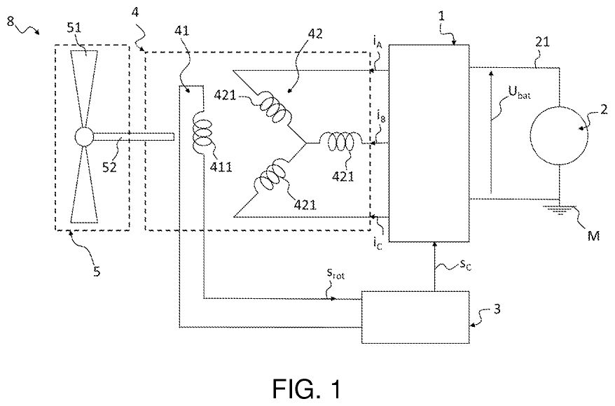

FIG. 1 illustrates an electrical system intended to be installed for example in a motor vehicle, not shown, and an electric power for which—represented by a voltage U_{bat}—is provided by a battery 2 via a vehicle electrical system 21. In the example illustrated in FIG. 1, such an electrical system forms a motorized-fan unit 8 in accordance with the third aspect of the invention.

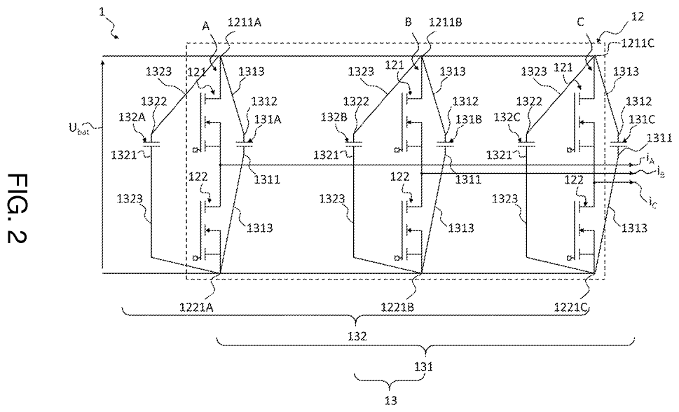

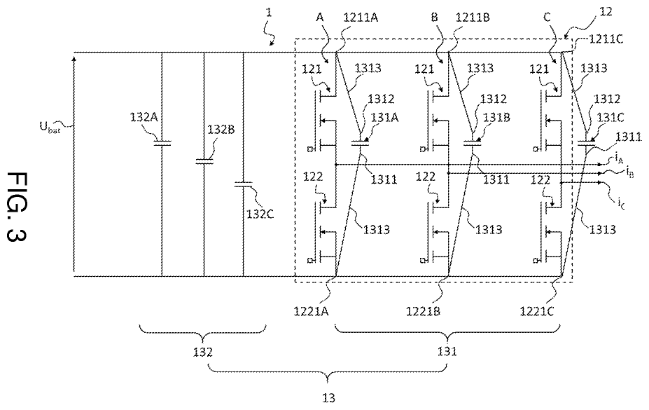

Such a motorized-fan unit 8 comprises an electric motor 4 driven by a control circuit 1, a rotor of the electric motor 4 being mechanically coupled to a shaft 52 rotating a propeller 51 of a fan 5. The control circuit 1 is in accordance with the first aspect of the invention and will be described later on with reference to FIGS. 2 and 3.

The electric motor 4 driven by the control circuit 1 can be of any type, and in particular of the type of a DC motor, for example, preferably polyphase and driven by a power bridge. The electric motor 4 comprises an armature element 41 and an inductor element 42. In the example illustrated in FIG. 1, the armature element 41 is a rotor of the electric motor 4; and the inductor element 42 is a stator of said electric motor 4. Advantageously, the inductor element 42 comprises a number N of electrical windings 421. In the example illustrated in FIG. 1, N is equal to 3. According to a particular embodiment of the invention, the electrical windings 421 of the inductor element 42 are arranged in a so-called “star” electrical configuration, all the electrical windings 421 being electrically connected to one another at a common electrical terminal. Alternatively, other electrical configurations can be envisaged, such as for example a delta or ring configuration.

According to another variant of the invention, the electric motor 4 is of the brushless type, the rotor of the electric motor 4 comprising one or more permanent magnets forming the armature element 41, and the electrical windings 421 of the stator then form the inductor element 42 of the electric motor 4.

The electric motor 4 is driven by a control circuit 1 that allows selective or collective production of the phase currents i_{A}, i_{B}, i_{C} of each of the electrical windings 421 of the inductor element 42 of said electric motor 4. The control circuit 1 is itself driven by a control module 3 that generates one or more control signals sc for the control circuit 1, as will be described in more detail with reference to FIGS. 2 and 3. In addition, the control module 3 is also configured to determine an induced current iᵣₒₜ at the armature element 41 of the electric motor 4.

The control circuit 1 is branched off from the battery 2 of the motor vehicle, between a positive terminal and a ground terminal M, through the vehicle electrical system 21. The ground terminal M is advantageously electrically connected to a chassis of the motor vehicle for reasons of electrical safety.

With reference to FIG. 2, two exemplary embodiments of a control circuit 1 in accordance with the first aspect of the invention are described, each control circuit 1 comprising a power bridge 12 and a filtering device 13.

The power bridge 12 comprises at least one power branch A, B, C, in order to produce at least one phase current i_{A}, i_{B}, i_{C} for each of the electrical windings 421 of the inductor element 42 of said electric motor 4. All the power branches A, B, C are firstly branched off from one another, and polarized by the voltage U_{bat} delivered by the battery 2 of the motor vehicle. In the examples illustrated in FIGS. 2 and 3, in correspondence with the motorized-fan unit 8 illustrated in FIG. 1, the power bridge 12 comprises three power branches A, B, C, each of the power branches A, B, C being associated with one of the electrical windings 421.

Each power branch A, B, C comprises two power switches 121. Each power switch 121 is configured to produce the corresponding phase current i_{A}, i_{B}, i_{C}. The phase current i_{A}, i_{B}, i_{C} produced by the power switches of each branch A, B, C of the control circuit 1 is of the type of a pulse-width modulation signal in order to control the rotation and/or the speed of rotation of the electric motor 4. For this purpose, each power switch 121 is alternately configured in an on conduction state—in which it has a very low resistance between its terminals—and in an off conduction state—in which it has a very high resistance between its terminals. The toggling of the power switches 121 between their on and off conduction states is driven by the control module 3 and allows the characteristics of the corresponding phase currents i_{A}, i_{B}, i_{C}, such as for example a frequency and/or a duty cycle, to be controlled.

Each power switch 121 is advantageously of the type of a power transistor, such as for example a MOS, a MOSFET, preferably N doped as in the examples illustrated in FIGS. 2 and 3.

For each power branch A, B, C, the two power switches 121 are advantageously electrically connected at a common terminal, for example via a drain terminal of a first power transistor and via a source terminal of a second power transistor of the same power branch A, B, C. Subsequently, the terminal common to the two power components 121 is then electrically connected to one of the electrical windings 421 of the electric motor 4 in order to control an electric current flowing through it.

According to the first aspect of the invention, in order to filter electromagnetic radiation from the power bridge 12 during operation thereof, the filtering device 13 comprises a first filtering device 131. For this purpose, the first filtering device 131 comprises three filtering branches each comprising a filtering capacitor 131A, 131B, 131C, respectively. As can be seen in FIGS. 2 and 3, each filtering branch of the first filtering device 131 is firstly branched off from the power bridge 12 and secondly placed in parallel with the voltage U_{bat} delivered by the battery 2 of the motor vehicle.

More particularly, each filtering branch of the first filtering device 131 is associated with one of the power branches A, B, C of the power bridge 12. In other words, each filtering branch of the first filtering device 131 is branched off from one of the power branches A, B, C of the power bridge 12, so that each of the filtering capacitors 131A, 131B, 131C of the first filtering device 131 is branched off from the power switches 121, 122 forming one of said power branches A, B, C.

In line with the invention according to its first aspect, one of the connection terminals 1311, 1312 of the first filtering device 131 is located near a connection point 1211A, 1221A, 1211B, 1221B, 1211C, 1221C of the power bridge 12, so that a length of an electrical conductor 1313 connecting said connection terminal 1311, 1312 of the first filtering device 131 to the connection point 1211A-1211C, 1221A-1221C of the power bridge 12 is less than or equal to 20 mm.

As can be seen in FIGS. 2 and 3, each connection terminal 1311, 1312 of the first filtering device 131 is located near the corresponding connection point 1211A-1211C, 1221A-1221C of the power bridge 12, so that the length of an electrical conductor 1313 is less than or equal to 20 mm.

A length of 20 millimeters is in fact a maximum value beyond which the antenna effects become too great for the technical problem of the present invention.

The first filtering device 131 is advantageously of the type of a low-pass filter, a cutoff frequency of which is between 800 kHz and 1.2 MHz, a value of the filtering capacitors 131A-131C of said first filtering device 131 being greater than 1 mF, and preferably equal to 2700 μF.

Additionally, in the exemplary embodiments illustrated in FIGS. 2 and 3, the filtering device 13 of the control circuit 1 also comprises a second filtering circuit 132. The second filtering device 132, which is optional for solving the technical problem, allows the performance of the filtering device 13 to be improved by offering a cutoff frequency that is different than that of the first filtering device. For this purpose, the second filtering device 132 is advantageously of the type of a low-pass filter, a cutoff frequency of which is greater than that of the first filtering device 131, for example greater than 100 MHz.

The second filtering device 132 comprises one or more filtering branches that are firstly branched off from the power bridge 12 and secondly arranged in parallel with the voltage U_{bat} delivered by the battery 2 of the motor vehicle.

According to a first exemplary embodiment illustrated in FIG. 2, each filtering branch of the second filtering device 132 is associated with one of the power branches A, B, C of the power bridge 12. In other words, each filtering branch of the second filtering device 132 is branched off from one of the power branches A, B, C of the power bridge 12, so that each of the filtering capacitors 132A, 132B, 132C of the second filtering device 132 is branched off from the power switches 121, 122 forming one of said power branches A, B, C.

In this first exemplary embodiment, one of the connection terminals 1321, 1322 of the second filtering device 132 is located near one of the connection terminals 1211A-1211C, 1221A-1221C of the power bridge 12, so that a length of an electrical connector 1323 connecting said connection terminal 1321, 1322 of said second filtering device 132 to the connection point 1211A-1211C, 1221A-1221C of the power bridge 12 is less than or equal to 20 mm.

As can be seen in FIG. 2, each connection terminal 1321, 1322 of the second filtering device 132 is located near the corresponding connection point 1211A-1211C, 1221A-1221C of the power bridge 12, so that the length of the corresponding electrical connector 1323 is less than or equal to 20 mm.

A length of 20 millimeters is in fact a maximum value beyond which the antenna effects become too great for the technical problem of the present invention.

According to a second exemplary embodiment illustrated in FIG. 3, the filtering branches of the second filtering device 132 are grouped together in front of the power bridge 12, the three power branches of said second filtering device 132 all being branched off from the power bridge 12.

In the first or the second exemplary embodiment, each filtering branch of the second filtering device 132 comprises a filtering capacitor 132A-132C. A capacitance value of each filtering capacitor 132A-132C of the second filtering device 132 is advantageously less than 1 μF, and preferably between 100 nF and 300 nF.

Optionally, in the second exemplary embodiment illustrated in FIG. 3, all the filtering capacitors 132A-132C of the second filtering device 132 can be grouped together as a single equivalent filtering capacitor branched off from the power bridge 12.

In summary, the invention relates to a control circuit 1 of an electric motor 4, the control circuit 1 comprising a filtering device 13 in order to filter the high frequencies likely to produce perturbing electromagnetic radiation when the electric motor 4 is driven. To this end, the filtering device 13 comprises a first filtering device 131 branched off from a power bridge 12 driving the electric motor 4, each filtering branch forming the first filtering device 131 being located near the power bridge 12 and/or one of the corresponding power branches A, B, C of said power bridge 12 so that a length of an electrical conductor 1313 connecting said filtering branch to said power branch is less than 20 mm.

Of course, the invention is not limited to the examples that have just been described, and numerous modifications can be made to these examples without departing from the scope of the invention. In particular, the various features, forms, variants and embodiments of the invention can be associated with each other, in various combinations, provided that they are not incompatible or mutually exclusive. In particular, all of the variants and embodiments described above can be combined with each other.

1. A control circuit of an electric motor, the control circuit comprising:
a power bridge comprising at least one power branch, the power bridge being configured to drive the electric motor; and
a first filtering device comprising at least one filtering branch arranged in parallel with the power bridge via two connection terminals, in order to filter electromagnetic radiation from said power bridge,
wherein at least one of the connection terminals of the first filtering device is located near a connection point of the power bridge, so that a length of an electrical conductor connecting said connection terminal of the first filtering device to the connection point of the power bridge is less than or equal to 20 mm.

2. The control circuit as claimed in claim 1, wherein each connection terminal of the first filtering device is located near a connection point of the power bridge, so that a length of the electrical conductor connecting each connection terminal of the first filtering device to the corresponding connection point of the power bridge is less than or equal to 20 mm.

3. The control circuit as claimed in claim 1, wherein the first filtering device comprises a number of filtering branches equal to a number of power branches of the power bridge, each filtering branch being associated with a single power branch, so that a length of the electrical conductor connecting the connection terminal of each filtering branch to the corresponding connection point of the power branch is less than or equal to 20 mm.

4. The control circuit as claimed in claim 1, wherein the first filtering device is of the type of a low-pass filter, a cutoff frequency of which is between 800 kHz and 1.2 MHz.

5. The control circuit as claimed in claim 1, wherein each filtering branch of the first filtering device comprises a filtering capacitor, a capacitance value of the filtering capacitor being greater than 1 mF.

6. The control circuit as claimed in claim 1, wherein the control circuit comprises a second filtering circuit comprising at least one filtering branch arranged in parallel with the power bridge via two connection terminals.

7. The control circuit as claimed in claim 6, wherein a cutoff frequency of the second filtering circuit is greater than a cutoff frequency of the first filtering circuit.

8. The control circuit as claimed in claim 6, wherein the second filtering device comprises a number of filtering branches equal to a number of power branches of the power bridge, each filtering branch being associated with a single power branch, so that a length of the electrical connector connecting the connection terminal of each filtering branch to the corresponding connection point of the power branch is less than or equal to 20 mm.

9. The control circuit as claimed in claim 6, wherein the second filtering device is of the type of a low-pass filter, a cutoff frequency of which is greater than 100 MHz, each filtering branch of the second filtering device comprising a filtering capacitor, a capacitance value of which is less than 1 μF.

10. The control circuit as claimed in claim 9, in which the filtering capacitor of each filtering branch of the second filtering device is of the type of a capacitive film or a ceramic capacitor.

11. A motorized-fan unit for motor vehicles, said motorized-fan unit comprising:
a fan rotated by an electric motor; and
a control circuit configured to drive the electric motor, the control circuit comprising:
a power bridge comprising at least one power branch, the power bridge being configured to drive the electric motor; and
a first filtering device comprising at least one filtering branch arranged in parallel with the power bridge via two connection terminals to filter electromagnetic radiation from said power bridge,
wherein at least one of the connection terminals of the first filtering device is located near a connection point of the power bridge, so that a length of an electrical conductor connecting said connection terminal of the first filtering device to the connection point of the power bridge is less than or equal to 20 mm.
